(19) United States
(12) Patent Application Publication
(10) Pub. No.: US 2026/0172330 A1
(43) Pub. Date: Jun. 18, 2026

(54) METHOD, DEVICE, AND SYSTEM WITH COLLECTIVE OPERATION

(71) Applicant: Samsung Electronics Co., Ltd., Suwon-si (KR)

(72) Inventors: Sungjoon PARK, Suwon-si (KR); Mincheol KANG, Suwon-si (KR); Changue JUNG, Suwon-si (KR); Kyung-no JOO, Suwon-si (KR)

(73) Assignee: Samsung Electronics Co., Ltd., Suwon-si (KR)

(21) Appl. No.: 19/303,957

(22) Filed: Aug. 19, 2025

(30) Foreign Application Priority Data
Dec. 18, 2024 (KR) 10-2024-0189980

(51) Int. Cl. H04L 43/02; H04L 12/18; H04L 43/04

(52) U.S. Cl. CPC H04L 43/02; H04L 12/18; H04L 43/04

(57) ABSTRACT

A processor-implemented method includes generating, in response to receiving a data portion from each of a plurality of endpoints, partial collective data by processing received data portions, receiving, from network devices, partial collective data generated by each of the network devices, and generating collective data by processing the partial collective data generated by a master network device and the partial collective data received from the network devices.

### CROSS-REFERENCE TO RELATED APPLICATIONS

This application claims the benefit under 35 USC § 119(a) of Korean Patent Application No. 10-2024-0189980, filed on Dec. 18, 2024 in the Korean Intellectual Property Office, the entire disclosure of which is incorporated herein by reference for all purposes.

### BACKGROUND

### 1. Field

The following description relates to a method, device, and system with a collective operation.

### 2. Description of Related Art

A collective operation may be used to distribute a computing workload for data processing between multiple endpoints or node devices and to combine data generated in an intermediate process into a complete result. In a collective operation, a network device may collect data from multiple endpoints and combine (or reduce) the data into one value. The network device may transmit (or broadcast) the combined value to the endpoints. In tasks such as high-performance computing (HPC) or training of an artificial intelligence model, the collective operation may accelerate the entire operational task and efficiently process a network task.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, a processor-implemented method includes generating, in response to receiving a data portion from each of a plurality of endpoints, partial collective data by processing received data portions, receiving, from network devices, partial collective data generated by each of the network devices, and generating collective data by processing the partial collective data generated by a master network device and the partial collective data received from the network devices.

The data portion received from each of the plurality of endpoints may be one of a plurality of data portions generated by each of the plurality of endpoints by splitting data associated with an operation to be performed collectively.

The data portion received from each of the plurality of endpoints may include an identifier indicating a corresponding endpoint among the plurality of endpoints.

The generating of the partial collective data by processing the received data portions, in response to receiving the data portion from each of the plurality of endpoints, may include generating the partial collective data by processing the received data portions based on the identifier of each of the received data portions, and the identifier may indicate a corresponding endpoint.

The partial collective data received from the network devices may be generated by each of the network devices by processing data portions received from the plurality of endpoints.

The method may include broadcasting the collective data to the plurality of endpoints.

The method may include receiving, from one or more boards other than a master board comprising the master network device, the network devices, and the plurality of endpoints, collective data generated by each of the one or more boards, and generating inter-board collective data by processing the collective data generated by the master network device of the master board and the collective data received from the one or more boards.

One or more portions of the collective data received from the one or more boards may be generated by a master network device of a corresponding board.

One or more portions of the collective data received from the one or more boards may be generated by an arbitrary endpoint of a corresponding board.

The method may include broadcasting the inter-board collective data to the one or more boards.

In one or more general aspects, a non-transitory computer-readable storage medium may store code that, when executed by one or more processors, configures the one or more processors to perform any one, any combination, or all of operations and/or methods disclosed herein.

In one or more general aspects, a processor-implemented method includes, in response to receiving a data portion from a plurality of endpoints, generating, by each of network devices, partial collective data by processing received data portions, broadcasting, by each of the network devices, the partial collective data to the plurality of endpoints, and generating, by each of the plurality of endpoints, collective data by processing partial collective data received from the network devices.

The method may include generating, by each of the plurality of endpoints, a plurality of data portions by splitting data associated with an operation to be performed collectively, and transmitting, by each of the plurality of endpoints, each of the plurality of data portions to different network devices.

The data portion received from each of the plurality of endpoints may include an identifier indicating a corresponding endpoint among the plurality of endpoints.

The generating of the partial collective data by processing the received data portions, in response to receiving the data portion from each of the plurality of endpoints, may include generating the partial collective data by processing the received data portions based on the identifier of each of the received data portions, and the identifier may indicate a corresponding endpoint.

The method may include obtaining, by an arbitrary network device among the network devices, the collective data from one of the plurality of endpoints, receiving, by the arbitrary network device, from one or more boards other than a master board comprising the network devices and the plurality of endpoints, collective data generated by each of the one or more boards, and generating, by the arbitrary network device, inter-board collective data by processing the collective data generated by one of the plurality of endpoints of the master board and the collective data received from the one or more boards.

One or more portions of the collective data received from the one or more boards may be generated by a master network device of a corresponding board.

One or more portions of the collective data received from the one or more boards may be generated by an arbitrary endpoint of a corresponding board.

The method may include broadcasting the inter-board collective data to the one or more boards.

In one or more general aspects, a master network device includes one or more processors configured to generate, in response to receiving a data portion from each of a plurality of endpoints, partial collective data by processing received data portions, receive, from network devices, partial collective data generated by each of the network devices, and generate collective data by processing the partial collective data generated by the master network device and the partial collective data received from the network devices.

Other features and aspects will be apparent from the following detailed description, the drawings, and the claims.

### BRIEF DESCRIPTION OF THE DRAWINGS

FIG. 1A illustrates an example of a collective operation system.

FIG. 1B illustrates an example of a collective operation system.

FIG. 2 illustrates an example of a network device.

FIG. 3 illustrates an example of a method of generating collective data.

FIG. 4 illustrates a flowchart of an example of an operating method of a master network device.

FIG. 5 illustrates an example of a method of generating collective data.

FIG. 6 illustrates a flowchart of an example of an operating method of a collective operation system.

FIG. 7 illustrates an example of a board-to-board collective operation system.

FIG. 8 illustrates a flowchart of an example of a method of generating inter-board collective data.

FIG. 9 illustrates an example of a board-to-board collective operation system.

Throughout the drawings and the detailed description, unless otherwise described or provided, the same drawing reference numerals may be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

Although terms such as “first,” “second,” and “third,” or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but is used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on,” “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” to specify the presence of stated features, numbers, operations, members, elements, and/or combinations thereof, other embodiments may exist where one or more of the stated features, numbers, operations, members, elements, and/or combinations thereof are not present.

Unless otherwise defined, all terms including technical and scientific terms used herein have the same meaning as those commonly understood by one of ordinary skill in the art to which the present disclosure pertains and after an understanding of the present disclosure. Terms such as those defined in commonly used dictionaries are to be interpreted as having a meaning that is consistent with their meaning in the context of the relevant art and the present disclosure, and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment,” and “one or more examples” has a same meaning as “in one or more embodiments”).

Hereinafter, examples are described in detail with reference to the accompanying drawings. When describing the examples with reference to the accompanying drawings, like reference numerals refer to like components and a repeated description related thereto is omitted.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

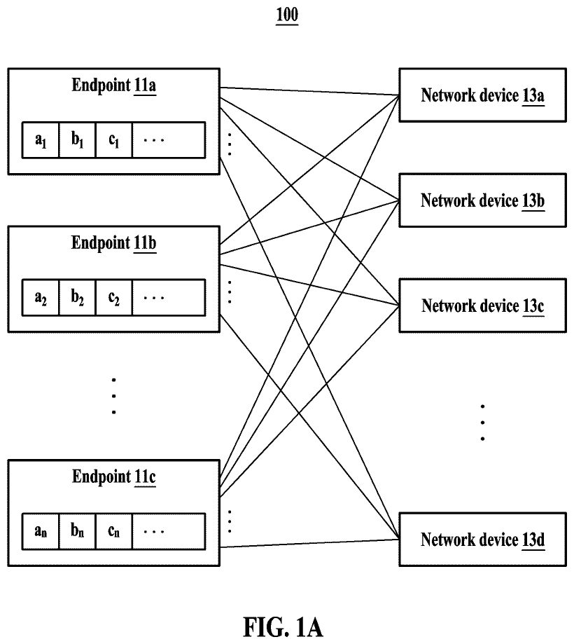

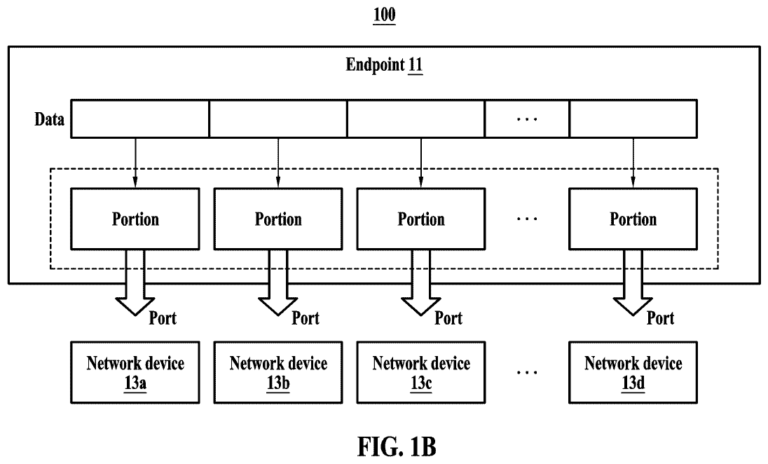

FIG. 1A illustrates an example of a collective operation system.

Referring to FIG. 1A, a collective operation system (hereinafter, a system) 100 may include a plurality of endpoints 11a, 11b, and 11c and a plurality of network devices 13a, 13b, 13c, and 13d.

The system 100 may collectively perform operations (or computing tasks) by the endpoints 11a, 11b, and 11c and the network devices 13a, 13b, 13c, and 13d. The endpoints 11a, 11b, and 11c and/or the network devices 13a, 13b, 13c, and 13d may perform part of operations of the system 100.

The endpoints 11a, 11b, and 11c may be computing devices. The endpoints 11a, 11b, and 11c may include at least one processor including processing circuitry. The endpoints 11a, 11b, and 11c may include, for example, a graphics processing unit (GPU), a central processing unit (CPU), a neural processing unit (NPU), and/or a tensor processing unit (TPU). The endpoints 11a, 11b, and 11c may also represent a system on chip (SoC) including at least one processor.

The endpoints 11a, 11b, and 11c may include one or more network interfaces. For example, the endpoints 11a, 11b, and 11c may include multi-ports. Each of the endpoints 11a, 11b, and 11c may be connected to the plurality of network devices 13a, 13b, 13c, and 13d via the multi-ports.

The network devices 13a, 13b, 13c, and 13d may be a switch, a hub, a router, and/or any other devices for transmitting and receiving data. The network devices 13a, 13b, 13c, and 13d may include one or more network interfaces. The network devices 13a, 13b, 13c, and 13d may include at least one processor including a processing circuit and a memory including one or more storage media storing instructions.

The network devices 13a, 13b, 13c, and 13d may each perform part of the operations of the system 100. The network devices 13a, 13b, 13c, and 13d may receive data from the endpoints 11a, 11b, and 11c and perform collective operations on the data received from each of the endpoints 11a, 11b, and 11c. The network devices 13a, 13b, 13c, and 13d may transmit data generated as a result of the collective operations to the endpoints 11a, 11b, and 11c.

Referring to FIG. 1B, an endpoint 11 may be one of the endpoints 11a, 11b, and 11c shown in FIG. 1A. The endpoint 11 may store (or include) data associated with an operation to be performed collectively in the system 100. The endpoint 11 may generate a plurality of data portions by splitting the data.

The endpoint 11 may transmit each of the data portions to the different network devices 13a, 13b, 13c, and 13d connected to multi-ports of the endpoint 11. Each of the network devices 13a, 13b, 13c, and 13d may form a plane (or a path) for a collective operation of each data portion. Thus, the system 100 may represent a multi-plane network structure composed of the plurality of network devices 13a, 13b, 13c, and 13d connected to the endpoint 11 via the multi-ports.

Each of the endpoints 11a, 11b, and 11c shown in FIG. 1A may generate the plurality of data portions by splitting the data associated with the operation to be performed collectively. For example, the endpoint 11a may generate data portions (e.g., a₁, b₁, c₁, . . . ) by splitting the data. The endpoint 11b may generate data portions (e.g., a₂, b₂, c₂, . . . ) by splitting the data. The endpoint 11c may generate data portions (e.g., aₙ, bₙ, cₙ, . . . ) by splitting the data.

Each of the endpoints 11a, 11b, and 11c may transmit the plurality of data portions to the different network devices 13a, 13b, 13c, and 13d. Each of the network devices 13a, 13b, 13c, and 13d may receive a data portion from each of the endpoints 11a, 11b, and 11c. For example, the network device 13a may receive a data portion a₁ from the endpoint 11a, a data portion a₂ from the endpoint 11b, and a data portion aₙ from the endpoint 11c. The network device 13b may receive a data portion b₁ from the endpoint 11a, a data portion b₂ from the endpoint 11b, and a data portion bₙ from the endpoint 11c. The network device 13c may receive a data portion c1 from the endpoint 11a, a data portion c2 from the endpoint 11b, and a data portion cn from the endpoint 11c.

Each of the network devices 13a, 13b, 13c, and 13d may generate partial collective data by processing received data portions. Processing data portions may refer to performing a collective operation on the data portions by coalescing, combining, and/or aggregating the data portions. A process in which the network devices 13a, 13b, 13c, and 13d generate the partial collective data may be referred to as a partial collective operation.

For example, the network device 13a may generate partial collective data A by processing the data portions (e.g., a₁, a₂, . . . , aₙ). The network device 13b may generate partial collective data B by processing the data portions (e.g., b₁, b₂, . . . , bₙ). The network device 13c may generate partial collective data C by processing the data portions (e.g., c₁, c₂, . . . , cₙ).

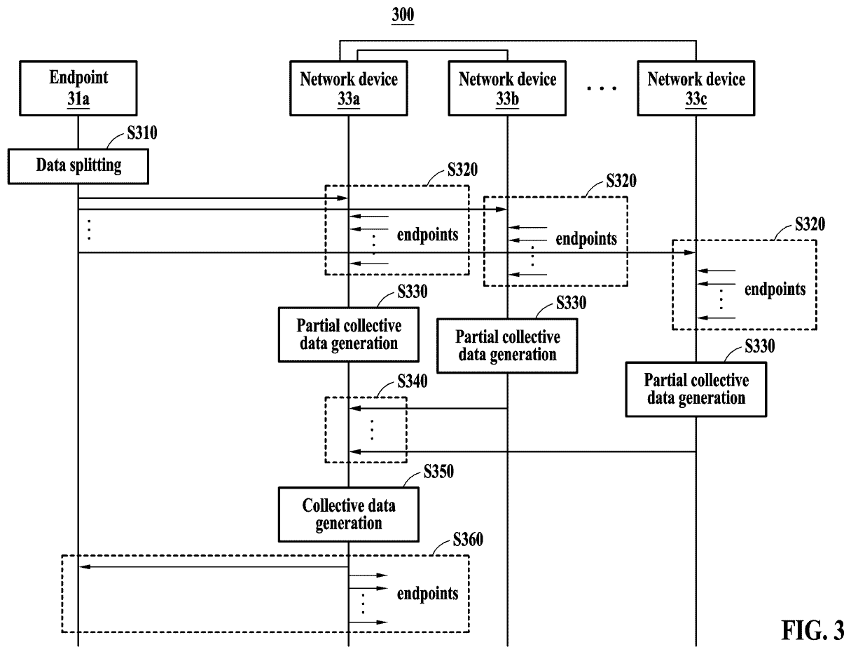

The system 100 may generate collective data by processing the partial collective data generated by the network devices 13a, 13b, 13c, and 13d. Processing partial collective data may refer to performing a collective operation on the partial collective data by coalescing, combining, and/or aggregating the partial collective data. A process in which the network devices 13a, 13b, 13c, and 13d generate the collective data may be referred to as a collective operation. An example of a method of generating collective data is described in detail with reference to FIGS. 3 to 6.

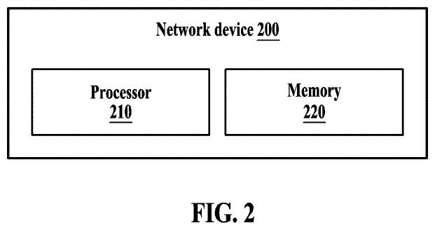

FIG. 2 illustrates an example of a network device.

A network device 200 may include a processor 210 (e.g., one or more processors) including a processing circuit and a memory 220 (e.g., one or more memories) including one or more storage media storing instructions. When individually or collectively executed by the processor 210, the instructions may cause the network device 200 to perform at least part of the operations described with reference to FIGS. 1A to 9 of the present disclosure. For example, the memory 220 may be or include a non-transitory computer-readable storage medium storing code that, when executed by the processor 210, configures the processor 210 to perform any one, any combination, or all of operations and/or methods disclosed herein with reference to FIGS. 1-9. The network device 200 may indicate the network devices 13a, 13b, 13c, and 13d of FIGS. 1A and 1B.

The network device 200 may include a communication portion (not shown) connected to the processor 210 and the memory 220 to transmit and receive data. The communication portion may be connected to an external device to transmit and receive data. Hereinafter, an expression “transmitting and receiving ‘A’” may refer to “transmitting and receiving ‘information or data representing A’.”

The communication portion may be implemented as circuitry within the network device 200. For example, the communication portion may include an internal bus and an external bus. In another example, the communication portion may be an element that connects the network device 200 and an external device. The communication portion may be an interface. For example, the communication portion may include one or more network interfaces. The communication portion may receive data from an external device and transmit the data to the processor 210 and the memory 220.

The processor 210 may process data received by the communication portion and/or data stored in the memory 220. A “processor” may be a hardware-implemented data processing device having a circuit that is physically structured to execute desired operations. The desired operations may include, for example, instructions or code included in a program. The hardware-implemented data processing device may include, for example, a microprocessor, a CPU, a GPU, a processor core, a multi-core processor, a multiprocessor, an application-specific integrated circuit (ASIC), and/or a field-programmable gate array (FPGA).

The processor 210 may control other components (e.g., hardware or software components) of the network device 200 and may perform various data processing or operations. As at least part of the data processing or operations, the processor 210 may store commands or data received from other components (e.g., the communication portion) in at least part of the memory 220, process the commands or the data stored in the memory 220, and store result data in the memory 220. The operations performed by the processor 210 may be substantially the same as the operations of the network device 200.

The memory 220 may store information necessary for the processor 210 to perform processing operations. The memory 220 (or one or more storage media included in the memory 220) may store instructions executed by the processor 210 and may store related information while software or programs are executed in the network device 200. The memory 220 may include, for example, one or more memories that are volatile memories and/or nonvolatile memories known in the art, such as random-access memory (RAM), dynamic random-access memory (DRAM), static random-access memory (SRAM), non-volatile random-access memory (NVRAM), persistent memory (PMEM), magneto-resistive random memory (MRAM), high bandwidth memory (HBM), and 3DXPoint.

The network device 200 may be connected to an external memory through the communication portion. For example, the external memory may include one or more volatile memory, non-volatile memory, RAM, flash memory, a hard disk drive, and an optical disk drive. The external memory may store a set of instructions (e.g., software) for operating the network device 200. The set of instructions for operating the network device 200 may be executed by the processor 210.

FIG. 3 illustrates an example of a method of generating collective data.

A collective operation system (hereinafter, a system) 300 may include a plurality of endpoints (e.g., an endpoint 31a) and a plurality of network devices 33a, 33b, and 33c. For ease of description, the arbitrary endpoint 31a (e.g., the endpoints 11a, 11b, or 11c of FIG. 1 or the endpoint 11 of FIG. 1B) among the plurality of endpoints of the system 300 is illustrated, and the system 300 may include other endpoints as well as the endpoint 31a.

The collective operation system 100 of FIGS. 1A and 1B may be the system 300 of FIG. 3. The system 300 may perform the partial collective operations described above with reference to FIGS. 1A and 1B.

The endpoint 31a may store (or include) data associated with an operation to be performed collectively. The endpoint 31a may generate a plurality of data portions by splitting the data. The endpoint 31a may transmit each of the data portions to the different network devices 33a, 33b, and 33c connected to multi-ports of the endpoint 31a. Each of the network devices 33a, 33b, and 33c may form a plane (or a path) for a collective operation of each data portion. Thus, the system 300 may represent a multi-plane network structure composed of the plurality of network devices 33a, 33b, and 33c connected to the endpoint 31a via the multi-ports.

Each of the plurality of endpoints of the system 300, including the endpoint 31a, may generate a plurality of data portions by splitting the data associated with the operation to be performed collectively in operation S310. Each of the endpoints may transmit the plurality of data portions to the different network devices 33a, 33b, and 33c. Each of the network devices 33a, 33b, and 33c may receive a data portion from each of the endpoints in operation S320.

Referring to FIG. 3, it is illustrated that the endpoint 31a sequentially transmits the data portions to the network devices 33a, 33b, and 33c, but examples are not limited thereto. Each of the plurality of endpoints of the system 300, including the endpoint 31a, may transmit the data portions to the network devices 33a, 33b, and 33c in parallel.

In operation S330, each of the network devices 33a, 33b, and 33c may generate partial collective data by processing the received data portions. Processing data portions may refer to performing a collective operation on the data portions by coalescing, combining, and/or aggregating the data portions. A process in which the network devices 33a, 33b, and 33c generate the partial collective data may be referred to as a partial collective operation.

One of the network devices 33a, 33b, and 33c of the system 300 may be a master network device. The master network device may perform a collective operation, which generates collective data by processing partial collective data.

In the system 300, for example, the network devices 33a, 33b, and 33c may exchange information on a work load and/or a resource load. The system 300 may set a network device, among the network devices 33a, 33b, and 33c, which has a largest remaining resource, as the master network device. Alternatively, the system 300 may set a network device selected based on a user input as the master network device.

In the system 300, the master network device may be provided with sufficient network interfaces that may be connected to other network devices. For example, the master network device may include multi-ports that may be connected to other network devices.

When the network device 33a is the master network device, the master network device may be connected to the network devices 33b and 33c other than the master network device via the multi-ports. In operation S340, the master network device may receive the partial collective data generated by each of the network devices 33b and 33c from the network devices 33b and 33c. The partial collective data received from the network devices 33b and 33c may be generated by each of the network devices 33b and 33c by processing the data portions received from the plurality of endpoints.

For example, the master network device may generate partial collective data (e.g., the partial collective data A) by processing the data portions (e.g., a₁, a₂, . . . , aₙ) received from the plurality of endpoints. The network device 33b may generate partial collective data (e.g., the partial collective data B) by processing the data portions (e.g., b₁, b₂, . . . , bₙ) received from the plurality of endpoints. The network device 33c may generate partial collective data (e.g., the partial collective data C) by processing the data portions (e.g., c₁, c₂, . . . , cₙ) received from the plurality of endpoints. The master network device may receive the partial collective data (e.g., the partial collective data B) from the network device 33b and receive the partial collective data (e.g., the partial collective data C) from the network device 33c. In another example, the master network device may generate both the partial collective data A and the partial collective data (e.g., B and/or C) of one or more other network devices (e.g., 33b and/or 33c), in response to determining that the one or more other network devices have failed (or are unable) to generate the partial collective data thereof, and/or in response to receiving the data portions received by the one or more other network devices from the one or more other network devices.

In operation S350, the master network device may generate collective data by processing the partial collective data generated in operation S330. For example, the master network device may generate collective data by processing the partial collective data (e.g., A) generated by the master network device and the partial collective data (e.g., B and C) received from the network devices 33b and 33c other than the master network device. Processing partial collective data may refer to performing a collective operation on the partial collective data by coalescing, combining, and/or aggregating the partial collective data (e.g., A, B, and C).

In operation S360, the master network device may transmit (e.g., broadcast) the collective data to the plurality of endpoints.

Referring to FIG. 3, it is illustrated that the network devices 33a, 33b, and 33c sequentially receive the data portions from each of the endpoints, that the master network device sequentially receives the partial collective data generated by each of the network devices 33b and 33c, and that the master network device sequentially broadcasts the collective data to the plurality of endpoints. However, examples are not limited thereto. The transmission and reception of the data portions, the partial collective data, and the collective data may each be performed in parallel.

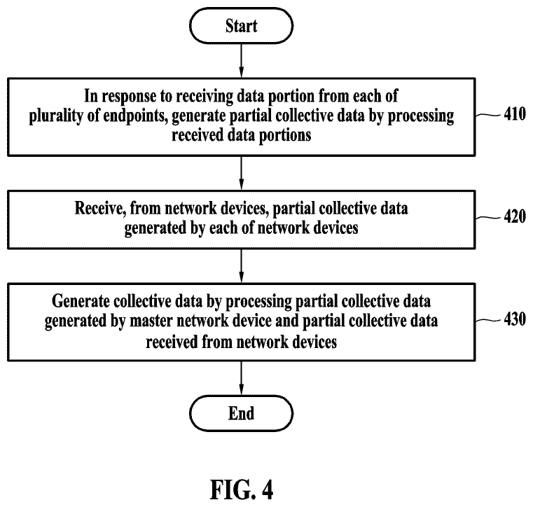

FIG. 4 illustrates a flowchart of an example of an operating method of a master network device. Operations 410 to 430 of FIG. 4 may be performed in the order and manner shown. However, the order of one or more of the operations may be changed, one or more of the operations may be omitted, two or more of the operations may be performed in parallel or simultaneously, and/or other operations may be additionally performed without departing from the spirit and scope of the example embodiments described herein.

Operations 410 to 430 below may be performed by a master network device (e.g., the network device 13a, 13b, 13c, or 13d of FIGS. 1A and 1B, the network device 200 of FIG. 2, and/or the master network device (or the network device 33a) of FIG. 3). The master network device may include at least some of the components of the network device 200 described in FIG. 2. For example, the master network device may include at least one processor (e.g., the processor 210 of FIG. 2). The master network device may include a memory (e.g., the memory 220 of FIG. 2).

As described with reference to FIG. 3, in a collective operation system (e.g., the collective operation system 300 of FIG. 3), each of a plurality of endpoints (e.g., the endpoint 31a of FIG. 3) may generate a plurality of data portions by splitting data associated with an operation to be performed collectively. Each of the endpoints may transmit the plurality of data portions to different network devices (e.g., the network devices 33a, 33b, and 33c of FIG. 3). Each of the network devices may receive a data portion from each of the endpoints. One of the network devices of the collective operation system may be a master network device (e.g., the network device 33a of FIG. 3).

In operation 410, the master network device may, in response to receiving a data portion from each of the plurality of endpoints, generate partial collective data by processing the received data portions.

The data portion received from each of the plurality of endpoints may be one of the plurality of data portions generated by each of the plurality of endpoints by splitting data associated with the operation to be performed collectively. The data portion received from each of the plurality of endpoints may include an identifier indicating a corresponding endpoint among the plurality of endpoints.

The master network device may generate the partial collective data by processing the received data portions based on the identifier indicating the corresponding endpoint of each of the received data portions. For example, the master network device may process the received data portions without omission by referring to the identifier indicating the corresponding endpoint of each of the received data portions when generating the partial collective data.

The master network device may be connected to network devices other than the master network device (e.g., the network devices 33b and 33c of FIG. 3) via multi-ports.

In operation 420, the master network device may receive partial collective data generated by each of the network devices from the network devices other than the master network device.

The partial collective data received from the network devices may be generated by each of the network devices by processing the data portions received from the plurality of endpoints. Each of the network devices may generate the partial collective data by processing the received data portions based on the identifier indicating the corresponding endpoint of each of the received data portions.

In operation 430, the master network device may generate collective data by processing the partial collective data generated by the master network device and the partial collective data received from the network devices.

The master network device may broadcast the collective data to the plurality of endpoints. Each of the plurality of endpoints may receive the collective data from the master network device.

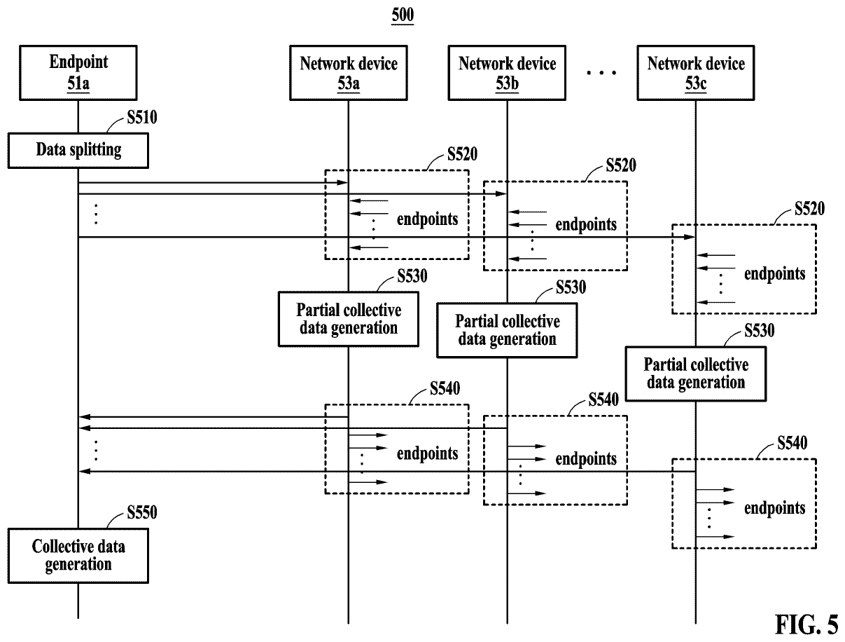

FIG. 5 illustrates an example of a method of generating collective data.

A collective operation system (hereinafter, a system) 500 may include a plurality of endpoints (e.g., an endpoint 51a) and a plurality of network devices 53a, 53b, and 53c. For ease of description, the arbitrary endpoint 51a (e.g., the endpoints 11a, 11b, and/or 11c of FIG. 1A and/or the endpoint 11 of FIG. 1B) among the plurality of endpoints of the system 500 is illustrated, and the system 500 may include other endpoints as well as the endpoint 51a.

The collective operation system 100 of FIGS. 1A and 1B may be the system 500 of FIG. 5. The system 500 may perform the partial collective operations described above with reference to FIGS. 1A and 1B.

The endpoint 51a may store (or include) data associated with an operation to be performed collectively. The endpoint 51a may generate a plurality of data portions by splitting the data. The endpoint 51a may transmit each of the data portions to different network devices 53a, 53b, and 53c connected to multi-ports of the endpoint 51a. Each of the network devices 53a, 53b, and 53c may form a plane (or a path) for a collective operation of each data portion. Thus, the system 500 may represent a multi-plane network structure composed of the plurality of network devices 53a, 53b, and 53c connected to the endpoint 51a via the multi-ports.

Each of the plurality of endpoints of the system 500, including the endpoint 51a, may generate a plurality of data portions by splitting the data associated with the operation to be performed collectively in operation S510. Each of the endpoints may transmit the plurality of data portions to the different network devices 53a, 53b, and 53c. Each of the network devices 53a, 53b, and 53c may receive a data portion from each of the endpoints in operation S520.

Referring to FIG. 5, it is illustrated that the endpoint 51a sequentially transmits the data portions to the network devices 53a, 53b, and 53c, but examples are not limited thereto. Each of the plurality of endpoints of the system 500, including the endpoint 51a, may transmit the data portions to the network devices 53a, 53b, and 53c in parallel.

In operation S530, each of the network devices 53a, 53b, and 53c may generate partial collective data by processing the received data portions. Processing data portions may refer to performing a collective operation on the data portions by coalescing, combining, and/or aggregating the data portions. A process in which the network devices 53a, 53b, and 53c generate the partial collective data may be referred to as a partial collective operation.

In operation S540, each of the network devices 53a, 53b, and 53c of the system 500 may broadcast the partial collective data to the plurality of endpoints. Each of the plurality of endpoints may receive the partial collective data from the network devices 53a, 53b, and 53c.

In operation S550, each of the plurality of endpoints may generate collective data by processing the partial collective data received from the network devices 53a, 53b, and 53c. Processing partial collective data may refer to performing a collective operation on the partial collective data by coalescing, combining, and/or aggregating the partial collective data.

For example, the network device 53a may generate partial collective data (e.g., A) by processing the data portions (e.g., a₁, a₂, . . . , aₙ) received from the plurality of endpoints. The network device 53a may broadcast the partial collective data (e.g., A) to the plurality of endpoints. The network device 53b may generate partial collective data (e.g., B) by processing the data portions (e.g., b₁, b₂, . . . , bₙ) received from the plurality of endpoints. The network device 53b may broadcast the partial collective data (e.g., B) to the plurality of endpoints. The network device 53c may generate partial collective data (e.g., C) by processing the data portions (e.g., c₁, c₂, . . . , cₙ) received from the plurality of endpoints. The network device 53c may broadcast the partial collective data (e.g., C) to the plurality of endpoints. Each of the plurality of endpoints may receive the partial collective data from the network devices 53a, 53b, and 53c. For example, the endpoint 51a may receive the partial collective data (e.g., A, B, and C) from the network devices 53a, 53b, and 53c.

Each of the plurality of endpoints may generate collective data by processing the partial collective data received from the network devices 53a, 53b, and 53c. For example, the endpoint 51a may generate the collective data by processing the partial collective data (e.g., A, B, and C) received from the network devices 53a, 53b, and 53c.

Referring to FIG. 5, it is illustrated that the network devices 53a, 53b, and 53c sequentially receive the data portions from each of the endpoints and that each of the network devices 53a, 53b, and 53c sequentially broadcasts the partial collective data to the plurality of endpoints. However, examples are not limited thereto. The transmission and reception of the data portions and the partial collective data may each be performed in parallel.

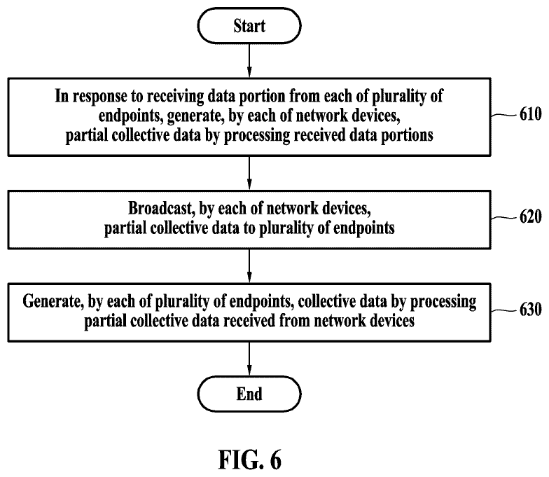

FIG. 6 illustrates a flowchart of an example of an operating method of a collective operation system. Operations 610 to 630 of FIG. 6 may be performed in the order and manner shown. However, the order of one or more of the operations may be changed, one or more of the operations may be omitted, two or more of the operations may be performed in parallel or simultaneously, and/or other operations may be additionally performed without departing from the spirit and scope of the example embodiments described herein.

Operations 610 to 630 below may be performed by a collective operation system (e.g., the collective operation system 100 of FIGS. 1A and 1B and/or the collective operation system 500 of FIG. 5). The collective operation system may include at least some of the components of the collective operation system 100 described with reference to FIGS. 1A and 1B. For example, the collective operation system may include a plurality of endpoints (e.g., 11a, 11b, and 11c) and a plurality of network devices (e.g., 13a, 13b, 13c, and 13d). Hereinafter, operations performed by the network devices and/or the endpoints may be understood as operations performed by the collective operation system.

As described with reference to FIG. 5, in the collective operation system (e.g., the collective operation system 500 of FIG. 5), each of the plurality of endpoints (e.g., the endpoint 51a of FIG. 5) may generate a plurality of data portions by splitting data associated with an operation to be performed collectively. Each of the endpoints may transmit the plurality of data portions to different network devices (e.g., the network devices 53a, 53b, and 53c of FIG. 5). Each of the network devices may receive a data portion from each of the endpoints.

In operation 610, each of the network devices may, in response to receiving a data portion from each of the plurality of endpoints, generate partial collective data by processing the received data portions.

The data portion received from each of the plurality of endpoints may include an identifier indicating a corresponding endpoint among the plurality of endpoints. Each of the network devices may generate the partial collective data by processing the received data portions based on the identifier indicating a corresponding endpoint of each of the received data portions.

In operation 620, each of the network devices may broadcast the partial collective data to the plurality of endpoints. Each of the plurality of endpoints may receive the partial collective data from each of the network devices.

In operation 630, each of the plurality of endpoints may generate collective data by processing the partial collective data received from the network devices.

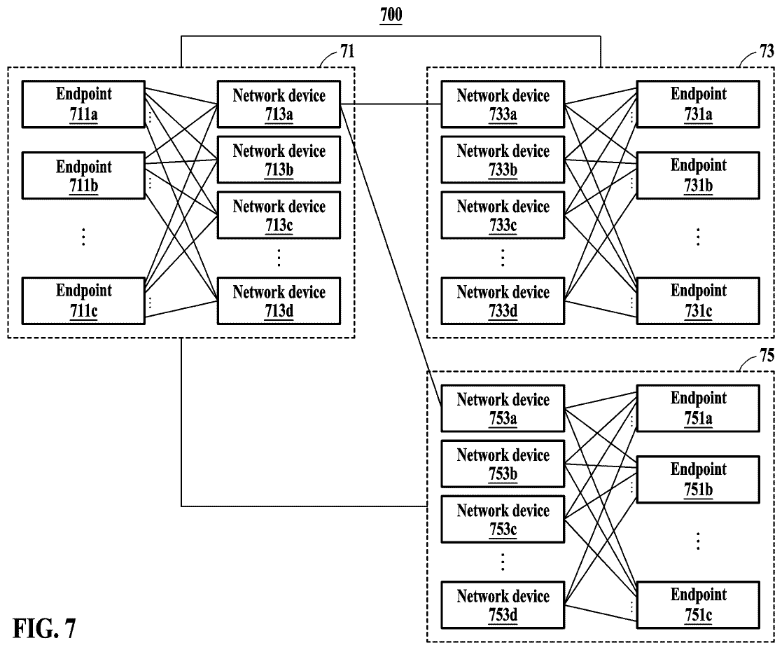

FIG. 7 illustrates an example of a board-to-board collective operation system.

A board-to-board collective operation system (hereinafter, a system) 700 may include boards 71, 73, and 75. Each of the boards 71, 73, and 75 may represent a collective operation system including a plurality of endpoints and a plurality of network devices (e.g., the network device 200 of FIG. 2). In the system 700, at least some boards may be connected to each other. For example, at least one network device in any board may be connected to a network device of another board. A board-to-board collective operation may be performed through a fabric structure of network devices forming an inter-board connection.

One of the boards 71, 73, and 75 of the system 700 may be a master board. The master board may perform a board-to-board collective operation, which generates inter-board collective data by processing collective data generated from each board. Hereinafter, a description is given on a case in which the board 71 is the master board.

The board 71 may represent the collective operation system 300 of FIG. 3. The board 71 may include a plurality of endpoints 711a, 711b, and 711c and a plurality of network devices 713a, 713b, 713c, and 713d. One of the network devices 713a, 713b, 713c, and 713d of the board 71 may be a master network device. The master network device may perform a collective operation, which generates collective data by processing partial collective data.

When the network device 713a is the master network device, the master network device may be connected to the network devices 713b, 713c, and 713d other than the master network device through multi-ports. The master network device may generate the partial collective data by processing data portions received from the plurality of endpoints 711a, 711b, and 711c. The master network device may receive, from the network devices 713b, 713c, and 713d, the partial collective data generated by each of the network devices 713b, 713c, and 713d. The partial collective data received from the network devices 713b, 713c, and 713d may be generated by each of the network devices 713b, 713c, and 713d by processing data portions received from the plurality of endpoints 711a, 711b, and 711c. The master network device may generate collective data by processing the partial collective data generated by the master network device and the partial collective data received from the network devices 713b, 713c, and 713d other than the master network device.

The board 73 may be the collective operation system 300 of FIG. 3 and/or the collective operation system 500 of FIG. 5. For example, when the board 73 is the collective operation system 300 of FIG. 3, the master network device (e.g., the network device 733a) may generate collective data by processing the partial collective data generated by the master network device and the partial collective data received from the network devices 733b, 733c, and 733d other than the master network device. For example, when the board 73 is the collective operation system 500 of FIG. 5, each of the plurality of endpoints 731a, 731b, and 731c may generate collective data by processing the partial collective data received from the network devices 733a, 733b, 733c, and 733d.

The master network device may generate collective data by processing the partial collective data generated by the master network device and the partial collective data received from the network devices 713b, 713c, and 713d other than the master network device.

The board 75 may be the collective operation system 300 of FIG. 3 and/or the collective operation system 500 of FIG. 5. For example, when the board 75 is the collective operation system 300 of FIG. 3, the master network device (e.g., the network device 753a) may generate collective data by processing the partial collective data generated by the master network device and the partial collective data received from the network devices 753b, 753c, and 753d other than the master network device. For example, when the board 75 is the collective operation system 500 of FIG. 5, each of the plurality of endpoints 751a, 735b, and 751c may generate collective data by processing the partial collective data received from the network devices 753a, 753b, 753c, and 753d.

Referring again to the board 71 (or, the master board and/or the collective operation system 300 of FIG. 3), the master network device (e.g., the network device 713a) of the board 71 may be connected to the network device 733a of the board 73 and the network device 753a of the board 75, respectively. The master network device of the board 71 may receive, from one or more boards 73 and 75 other than the board 71, collective data generated by each of the one or more boards 73 and 75. For example, when a network device (e.g., the network device 733a and the network device 753a) connected to the master network device of the board 71 is a master network device of a corresponding board, the master network device of the board 71 may receive, from the master network device of each board, collective data generated by the master network device of each board. For example, when the collective data is generated by each of the plurality of endpoints on a board to which the network device (e.g., the network device 733a and the network device 753a) connected to the master network device of the board 71 belongs, the collective data may be transmitted in the order of an arbitrary endpoint—the network device—the master network device of the board 71. For example, the network device 733a of the board 73 may receive the collective data from the endpoint 731a and transmit the received collective data to the master network device of the board 71. The network device 753a of the board 75 may receive the collective data from the endpoint 751a and transmit the received collective data to the master network device of the board 71.

The master network device of the board 71 may generate inter-board collective data by processing the collective data generated by the master network device of the board 71 and the collective data received from the one or more boards 73 and 75. Processing collective data may refer to performing a collective operation on the collective data by coalescing, combining, and/or aggregating the collective data.

The board 71 may represent the collective operation system 500 of FIG. 5. Each of the plurality of endpoints 711a, 711b, and 711c of the board 71 may generate collective data by processing the partial collective data received from the network devices 713a, 713b, 713c, and 713d.

An arbitrary network device among the network devices 713a, 713b, 713c, and 713d of the board 71 may obtain collective data from one of the plurality of endpoints 711a, 711b, and 711c. The arbitrary network device among the network devices 713a, 713b, 713c, and 713d may receive collective data from an arbitrary endpoint among the plurality of endpoints 711a, 711b, and 711c. For example, the network device 713a may receive collective data from the endpoint 711a.

The network device 713a may receive, from the one or more boards 73 and 75 other than the board 71, collective data generated by each of the one or more boards 73 and 75. As described above, the board 73 and the board 75 may be the collective operation system 300 of FIG. 3 and/or the collective operation system 500 of FIG. 5, respectively. For example, the network device 713a may receive, from the network device 733a of the board 73, collective data generated by the network device 733a and/or the endpoint 731a. The network device 713a may receive, from the network device 753a of the board 75, collective data generated by the network device 753a and/or the endpoint 751a. The network device 713a may generate inter-board collective data by processing the collective data received from the endpoint 711a and the collective data received from one or more boards 73 and 75 (or from the network device 733a and the network device 753a).

The board 71 (or the master board) may broadcast the inter-board collective data to other boards 73 and 75. For example, the network device 713a of the board 71 may transmit the inter-board collective data to the network device 733a of the board 73 and the network device 753a of the board 75. Within the boards 71, 73, and 75, the inter-board collective data may be broadcast to the endpoints of each board.

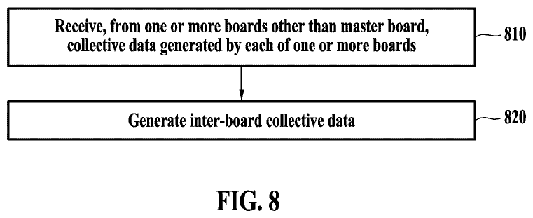

FIG. 8 illustrates a flowchart of an example of a method of generating inter-board collective data. Operations 810 and 820 of FIG. 8 may be performed in the order and manner shown. However, the order of one or more of the operations may be changed, one or more of the operations may be omitted, two or more of the operations may be performed in parallel or simultaneously, and/or other operations may be additionally performed without departing from the spirit and scope of the example embodiments described herein.

Operations 810 and 820 below may be performed by a master network device (e.g., the network device 13a, 13b, 13c, and/or 13d of FIGS. 1A and 1B, the network device 200 of FIG. 2, and/or the master network device 33a of FIG. 3. The master network device may include at least some of the components of the network device 200 described in FIG. 2. For example, the master network device may include at least one processor (e.g., the processor 210 of FIG. 2). The master network device may include a memory (e.g., the memory 220 of FIG. 2).

As described with reference to FIG. 7, one of the boards of the board-to-board collective operation system (e.g., the board-to-board collective operation system 700 of FIG. 7) may be a master board. The master board may perform a board-to-board collective operation, which generates inter-board collective data by processing collective data generated from each board. Hereinafter, operations performed by a master network device (e.g., network device 713a of FIG. 7) of the master board (e.g., the board 71 of FIG. 7) is described.

Operations 810 and 820 may be performed in response to operation 430 of generating collective data of FIG. 4 being performed.

In operation 810, the master network device may receive, from one or more boards (e.g., the boards 73 and 75 of FIG. 7) other than the master board including the master network device, network devices, and a plurality of endpoints, collective data generated by each of the one or more boards (e.g., the boards 73 and 75 of FIG. 7).

In operation 820, the master network device may generate inter-board collective data by processing collective data generated by the master network device of the master board and collective data received from the one or more boards.

Operations 810 and 820 may be performed by a collective operation system (e.g., the collective operation system 100 of FIGS. 1A and 1B, the collective operation system 300 of FIG. 3, and/or the collective operation system 500 of FIG. 5).

As described with reference to FIG. 7, one of the boards of the board-to-board collective operation system (e.g., the board-to-board collective operation system 700 of FIG. 7) may be a master board. The master board (e.g., the board 71 of FIG. 7) may perform a board-to-board collective operation, which generates inter-board collective data by processing collective data generated from each board. The master board may include at least some of the components of the board 71 described with reference to FIG. 7. For example, the master board may include a plurality of endpoints (e.g., the endpoints 711a, 711b, and 711c of FIG. 7) and a plurality of network devices (e.g., the network devices 713a, 713b, 713c, and 713d) of FIG. 7). Operations performed by the network device and/or the endpoint of the master board may be understood as operations performed by the master board (or the collective operation system). Hereinafter, operations performed by the master board (e.g., the board 71 of FIG. 7) are described.

Operations 810 and 820 may be performed after operation 630 of generating collective data of FIG. 6. In operation 630 of FIG. 6, each of the plurality of endpoints of the master board may generate collective data by processing partial collective data received from network devices.

An arbitrary network device among the network devices of the master board (e.g., the network device 713a of FIG. 7) may obtain collective data. The arbitrary network device among the network devices may receive collective data from an arbitrary endpoint among a plurality of endpoints (e.g., the plurality of endpoints 711a, 711b, and 711c of FIG. 7).

In operation 810, the arbitrary network device may receive, from one or more boards (e.g., the boards 73 and 75 of FIG. 7) other than the master board, collective data generated by each of the one or more boards.

In operation 820, the inter-board collective data may be generated, by the arbitrary network device, by processing the collective data generated by the arbitrary network device of the master board and the collective data received from the one or more boards.

At least a portion of the collective data received from the one or more boards may be generated by a master network device (e.g., the network device 733a and/or the network device 753a of FIG. 7) of a corresponding board.

At least a portion of the collective data received from the one or more boards may be generated by an arbitrary endpoint (e.g., the endpoint 731a, 731b, 731c, 733a, 733b, and/or 733c of FIG. 7) of a corresponding board.

The arbitrary network device may broadcast the inter-board collective data to the one or more boards.

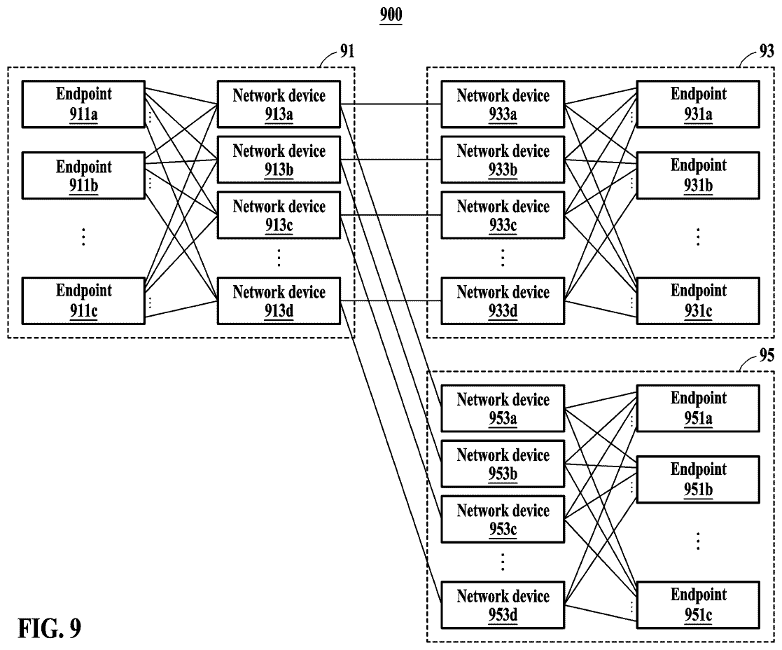

FIG. 9 illustrates an example of a board-to-board collective operation system.

A board-to-board collective operation system (hereinafter, a system) 900 may include boards 91, 93, and 95. Each of the boards 91, 93, and 95 may represent a collective operation system including a plurality of endpoints and a plurality of network devices (e.g., the network device 200 of FIG. 2). In the system 900, at least some of the boards may be connected to each other. For example, at least one network device in an arbitrary board may be connected to a network device of another board. A board-to-board collective operation may be performed through a fabric structure of network devices forming an inter-board connection. The board 93 may include network devices 933a, 933b, 933c, and 933d and endpoints 931a, 931b, and 931c. The board 95 may include network devices 953a, 953b, 953c, and 953d and endpoints 951a, 951b, and 951c.

One of the boards 91, 93, and 95 of the system 900 may be a master board. The master board may perform a board-to-board collective operation, which generates inter-board collective data by processing collective data generated from each board. Hereinafter, a description is given on a case in which the board 91 is the master board.

The board 91 may represent the collective operation system 100 of FIGS. 1A and 1B. The board 91 may include a plurality of endpoints 911a, 911b, and 911c and a plurality of network devices 913a, 913b, 913c, and 913d (e.g., the network device 200 of FIG. 2).

As described above with reference to FIGS. 1A and 1B, each of the network devices 913a, 913b, 913c, and 913d of the board 91 may, in response to receiving data portions from each of the plurality of endpoints 911a, 911b, and 911c, generate partial collective data by processing the received data portions.

Similarly to the board 91, the network devices of each of the boards 93 and 95 may perform a partial collective operation. For example, the network device 913a of the board 91 may generate partial collective data (e.g., A) by processing the data portions (e.g., a₁, a₂, . . . , aₙ). A network device 933a of the board 93 may generate partial collective data (e.g., A′) by processing the data portions (e.g., a₁′, a₂′, . . . , aₙ′). A network device 953a of the board 95 may generate partial collective data (e.g., A″) by processing the data portions (e.g., a₁″, a₂″, . . . , aₙ″). A network device 913b of the board 91 may generate partial collective data (e.g., B) by processing the data portions (e.g., b₁, b₂, . . . , bₙ). The network device 933a of the board 93 may generate partial collective data (e.g., B′) by processing the data portions (e.g., b₁′, b₂′, . . . , bₙ′). The network device 953a of the board 95 may generate partial collective data (e.g., B″) by processing the data portions (e.g., b₁″, b₂″, . . . , bₙ″).

Each of the network devices 913a, 913b, 913c, and 913d of the board 91 (or the master board) may be connected to the network devices of the one or more boards 93 and 95 other than the master board. For example, referring to FIG. 9, the network device 913a of the board 91 may be connected to the network device 933a of the board 93 and the network device 953a of the board 95. The network device 913b of the board 91 may be connected to the network device 933b of the board 93 and the network device 953b of the board 95. A repeated description is omitted. A board-to-board collective operation may be performed through the fabric structure of the network devices forming an inter-board connection.

Each of the network devices 913a, 913b, 913c, and 913d of the board 91 may receive, from the one or more boards 93 and 95 other than the master board, partial collective data generated by each of the one or more boards 93, 95. For example, the network device 913a of the board 91 may receive partial collective data from each of the network device 933a of the board 93 and the network device 953a of the board 95. The network device 913b of the board 91 may receive partial collective data from each of the network device 933b of the board 93 and the network device 953b of the board 95. A repeated description is omitted.

Each of the network devices 913a, 913b, 913c, and 913d of the board 91 may generate inter-board partial collective data by processing partial collective data generated by each of the network devices 913a, 913b, 913c, and 913d of the board 91 and partial collective data received from the one or more boards 93 and 95. For example, the network device 913a of the board 91 may generate inter-board partial collective data (e.g., A_{ib}) by processing the partial collective data (e.g., A) generated by the network device 913a and the partial collective data (e.g., A′ and A″) received from each of the network device 933a of the board 93 and the network device 953a of the board 95. The network device 913b of the board 91 may generate inter-board partial collective data (e.g., B_{ib}) by processing the partial collective data (e.g., B) generated by the network device 913b and the partial collective data (e.g., B′ and B″) received from each of the network device 933b of the board 93 and the network device 953b of the board 95.

An arbitrary network device among the network devices 913a, 913b, 913c, and 913d of the board 91 may receive, from the network devices other than the arbitrary network device among the network devices 913a, 913b, 913c, and 913d, inter-board partial collective data generated by each of the network devices other than the arbitrary network device. For example, the network device 913a may receive, from the network devices 913b, 913c, and 913d, inter-board partial collective data generated by each of the network devices 913b, 913c, and 913d.

The arbitrary network device (or the network device 913a) may generate inter-board collective data by processing the inter-board partial collective data generated by the arbitrary network device and the received inter-board partial collective data. For example, the network device 913a may generate inter-board collective data by processing the inter-board partial collective data (e.g., A_{ib}) generated by the network device 913a and the inter-board partial collective data (e.g., B_{ib}, . . . ) received from the network devices 913b, 913c, and 913d.

Referring to FIG. 9, a method performed by a board-to-board collective operation system may include generating, by each of the network devices 913a, 913b, 913c, and 913d, in response to receiving a data portion from each of the plurality of endpoints 911a, 911b, and 911c, partial collective data by processing received data portions, receiving, by each of the network devices 913a, 913b, 913c, and 913d, from the one or more boards 93 and 95 other than the master board 91 including the network devices 913a, 913b, 913c, and 913dand the plurality of endpoints 911a, 911b, and 911c, partial collective data generated by each of the one or more board 93 and 95, generating, by each of the network devices 913a, 913b, 913c, and 913d, inter-board partial collective data by processing partial collective data generated by each of the network devices 913a, 913b, 913c, and 913dof the master board 91 and partial collective data received from the one or more boards 93 and 95, receiving, by the arbitrary network device 913aamong the network devices 913a, 913b, 913c, and 913d, from the network devices 913b, 913c, and 913dother than the arbitrary network device 913aamong the network devices 913a, 913b, 913c, and 913d, inter-board partial collective data generated by each of the network devices 913b, 913c, and 913dother than the arbitrary network device 913a, and generating, by the arbitrary network device 913a, inter-board collective data by processing the inter-board partial collective data generated by the arbitrary network device 913aand the inter-board partial collective data received from the network devices 913b, 913c, and 913d.

The systems, endpoints, network devices, processors, memories, boards, system 100, endpoints 11a, 11b, and 11c, network devices 13a, 13b, 13c, and 13d, endpoint 11, network device 200, processor 210, memory 220, system 300, endpoint 31a, network devices 33a, 33b, and 33c, system 500 endpoint 51a, network devices 53a, 53b, and 53c, system 700, boards 71, 73, and 75, endpoints 711a, 711b, and 711c, network devices 713a, 713b, 713c, and 713d, endpoints 731a, 731b, and 731c, network devices 733a, 733b, 733c, and 733d, endpoints 751a, 735b, and 751c, network devices 753a, 753b, 753c, and 753d, system 900, boards 91, 93, and 95, endpoints 911a, 911b, and 911c, network devices 913a, 913b, 913c, and 913d, network devices 933a, 933b, 933c, and 933d, endpoints 931a, 931b, and 931c, network devices 953a, 953b, 953c, and 953d, and endpoints 951a, 951b, and 951cdescribed herein, including descriptions with respect to respect to FIGS. 1-9, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in, and discussed with respect to, FIGS. 1-9 that perform the operations described in this application are performed by computing hardware, for example, by one or more processors or computers, implemented as described above implementing instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method comprising:
generating, in response to receiving a data portion from each of a plurality of endpoints, partial collective data by processing received data portions;
receiving, from network devices, partial collective data generated by each of the network devices; and
generating collective data by processing the partial collective data generated by a master network device and the partial collective data received from the network devices.

2. The method of claim 1, wherein the data portion received from each of the plurality of endpoints is one of a plurality of data portions generated by each of the plurality of endpoints by splitting data associated with an operation to be performed collectively.

3. The method of claim 1, wherein the data portion received from each of the plurality of endpoints comprises an identifier indicating a corresponding endpoint among the plurality of endpoints.

4. The method of claim 3, wherein
the generating of the partial collective data by processing the received data portions, in response to receiving the data portion from each of the plurality of endpoints, comprises generating the partial collective data by processing the received data portions based on the identifier of each of the received data portions, and
the identifier indicates a corresponding endpoint.

5. The method of claim 1, wherein the partial collective data received from the network devices is generated by each of the network devices by processing data portions received from the plurality of endpoints.

6. The method of claim 1, further comprising broadcasting the collective data to the plurality of endpoints.

7. The method of claim 1, further comprising:
receiving, from one or more boards other than a master board comprising the master network device, the network devices, and the plurality of endpoints, collective data generated by each of the one or more boards; and
generating inter-board collective data by processing the collective data generated by the master network device of the master board and the collective data received from the one or more boards.

8. The method of claim 7, wherein one or more portions of the collective data received from the one or more boards are generated by a master network device of a corresponding board.

9. The method of claim 7, wherein one or more portions of the collective data received from the one or more boards are generated by an arbitrary endpoint of a corresponding board.

10. The method of claim 7, further comprising broadcasting the inter-board collective data to the one or more boards.

11. A non-transitory computer-readable storage medium storing code that, when executed by one or more processors, configures the one or more processors to perform the method of claim 1.

12. A processor-implemented method comprising:
in response to receiving a data portion from a plurality of endpoints, generating, by each of network devices, partial collective data by processing received data portions;
broadcasting, by each of the network devices, the partial collective data to the plurality of endpoints; and
generating, by each of the plurality of endpoints, collective data by processing partial collective data received from the network devices.

13. The method of claim 12, further comprising:
generating, by each of the plurality of endpoints, a plurality of data portions by splitting data associated with an operation to be performed collectively; and
transmitting, by each of the plurality of endpoints, each of the plurality of data portions to different network devices.

14. The method of claim 12, wherein the data portion received from each of the plurality of endpoints comprises an identifier indicating a corresponding endpoint among the plurality of endpoints.

15. The method of claim 14, wherein
the generating of the partial collective data by processing the received data portions, in response to receiving the data portion from each of the plurality of endpoints, comprises generating the partial collective data by processing the received data portions based on the identifier of each of the received data portions, and
the identifier indicates a corresponding endpoint.

16. The method of claim 12, further comprising:
obtaining, by an arbitrary network device among the network devices, the collective data from one of the plurality of endpoints;
receiving, by the arbitrary network device, from one or more boards other than a master board comprising the network devices and the plurality of endpoints, collective data generated by each of the one or more boards; and
generating, by the arbitrary network device, inter-board collective data by processing the collective data generated by one of the plurality of endpoints of the master board and the collective data received from the one or more boards.

17. The method of claim 16, wherein one or more portions of the collective data received from the one or more boards are generated by a master network device of a corresponding board.

18. The method of claim 16, wherein one or more portions of the collective data received from the one or more boards are generated by an arbitrary endpoint of a corresponding board.

19. The method of claim 16, further comprising broadcasting the inter-board collective data to the one or more boards.

20. A master network device comprising:
one or more processors configured to:
generate, in response to receiving a data portion from each of a plurality of endpoints, partial collective data by processing received data portions;
receive, from network devices, partial collective data generated by each of the network devices; and
generate collective data by processing the partial collective data generated by the master network device and the partial collective data received from the network devices.
